(19) United States
(12) Patent Application Publication
(10) Pub. No.: US 2014/0239841 A1
(43) Pub. Date: Aug. 28, 2014

(54) LED LAMP WITH ADJUSTABLE COLOR

(71) Applicant: Government of the United States as Represented by the Secretary of the Air Force, (US)

(72) Inventors: Jacob M. Gilman, Alexandria, VA (US); Michael E. Miller, Xenia, OH (US)

(73) Assignee: Government of the United States as Represented by Secretary of the Air Force, Wright-Patterson AFB, OH (US)

(21) Appl. No.: 13/781,111

(22) Filed: Feb. 28, 2013

(51) Int. Cl. H05B 37/02

(52) U.S. Cl. CPC H05B 37/02
USPC 315/250

(57) ABSTRACT

A color adjustable lamp. The lamp includes a first white emitter source having a plurality of colors so as to emit a first combined spectrum of light. A first drive signal having a first plurality of pulses at a first logic level and a second plurality of pulses at a second logic level operably controls the first white emitter source. The first and second pluralities of pulses having a first duty cycle. Changing a ratio of the pulses of the first and second pluralities, the first duty cycle, or both, changes the first combined spectrum.

### RIGHTS OF THE GOVERNMENT

The invention described herein may be manufactured and used by or for the Government of the United States for all governmental purposes without the payment of any royalty.

### FIELD OF THE INVENTION

The present invention relates to the structure and drive circuitry for a lamp and, more particularly, to a lamp capable of producing a multiplicity of colors and spectral power distributions of white light.

### BACKGROUND OF THE INVENTION

Lamps capable of producing multiple colors of light are known to satisfy many applications. For example, lamps for general purpose lighting allow “white” light to be generated in such a way to allow a user to adjust a correlated color temperature (“CCT”) of the light. Colorimetric coordinates of natural light during the day typically fall Bear a curve, referred to as the Planekian Locus or black body curve, within a CIE (Commission Internationale de l'Eclairage) chromaticity space. Methods for calculating daylight spectra for color temperatures between 4000 K and 25000 K have been specified within the art (CIE Publication No. 15, Colorimetry (Official Recommendations of the International Commission on illumination), Vienna, Austria. 2004.) Desirable lighting conditions include those designated as D50. D65, and D93, which correspond to daylight color temperatures of 5000 K. 6500 K, and 9300 K, respectively, Other desirable lighting conditions include so-called warmer lights that have lower correlated color temperatures and are more similar in appearance to the light produced by tungsten lamps.

It is also desirable that a lamp produce light, having a spectral power distribution that matches the standardized spectral power distributions of these standardized light sources. One metric for a degree of match between the spectral power distribution of the light produced by a lamp and a spectral power distribution of these standard lighting conditions is a color rendering index, CRI, (CIE Publication No. 13.3, Method of Measuring and Specifying Color-Rendering of Light Sources, Vienna, Austria, 1995).

CRI provides a method of specifying the degree to which the color appearance of a set of standard reflective objects illuminated by a lamp matches the appear of those same objects illuminated by light having the spectral power distribution to a standard source. Generally, lamps having a CRI of 80 or better provide a good match to the target spectral power distribution and are deemed to be of high quality.

Conventional lamps having color control are constructed from at least three different, independently controlled light sources. For example, some conventional lamps comprise three differently colored LEDs and a microprocessor configured to control the LEDs to attain a desired color of white light. However, the LEDs must all perform to a specified level, must generate a specified spectral power distribution, and may be independently controllable, Oftentimes, the control mechanism requires developing a solution to a complex set of simultaneous equations, which adds significant cost and complexity to the overall lamp system design. Moreover, color and luminance adjustability within these conventional lamps require a digital controller to sample a user control with at least 6 bits to support color change and at least an additional 8 bits to support luminance adjustability. The controller then solves a complex set of simultaneous equations to derive at least an 8 bit (although preferably 12 bit) drive signal for each of the at least three different, independently controlled light sources so as to support luminance and color adjustability. The resulting control electronics are often prohibitive to the adoption of lamps having color and luminance adjustability.

There remains a need for improved lamps and methods for providing color and luminance adjustability in a cost efficient manner.

### SUMMARY OF THE INVENTION

The present invention overcomes the foregoing problems and other shortcomings, drawbacks, and challenges of conventional lamp design by reducing the need for a complex microprocessor in a lamp with adjustable color control. While the invention will be described in connection with certain embodiments, it will be understood that the invention is not limited to these embodiments. To the contrary, this invention includes all alternatives. modifications, and equivalents as may he included within the spirit and scope of the present invention.

According to one embodiment of the present invention a color adjustable lamp includes a first white emitter source having a plurality of colors so as to emit a first combined spectrum of light. A first drive signal having a first plurality of pulses at a first logic level and a second plurality of pulses at a second logic level operably controls the first white emitter source. The first and second pluralities of pulses having a first duty cycle. Changing a ratio of the pulses of the first and second pluralities, the first duty cycle, or both, changes the first combined spectrum.

In accordance with another embodiment of the present invention, a pulse width modulated drive signal includes a clock signal, a first plurality of pulses, and a second plurality of pulses. A duty cycle of the dock signal is variable as is a number of pulses of the second plurality with respect to a number of pulses of the first plurality.

Still another embodiment of the present invention is directed to a color adjustable lamp having first and second white emitter sources, each having a plurality of colors and configured to emit a respective first and second contribution to a combined spectrum of light. A first drive signal is configured to control the first white emitter source. The first drive signal includes a first plurality of pulses at a first logic level and a second plurality of pulses at a second logic level, with pulses of the first and second pluralities having a first duty cycle. A second drive signal is configured to control the second white emitter source. The second drive signal includes a third plurality of pulses at the first logic level and a fourth plurality of pulses at the second logic level, with pulses of the third and fourth pluralities having a second duty cycle.

Other embodiments of the present invention is directed to a method of adjusting the combined spectrum of light and includes adjusting the relative first and second contributions of the first and second white emitter sources by adjusting one or more of a ratio of pulses of the first and second pluralities, a ratio of pulses of the third and fourth pluralities, the first duty cycle, and the second duty cycle.

Yet another embodiment of the present invention is directed to a method of generating a combined spectrum of light by a color adjustable lamp. The method includes emitting first and second contributions to the combined spectrum of light by driving respective first and second white emitter sources. The first white emitter source is driven by a first plurality of pulses at a first logic level and a second plurality of pulses at a second logic level, the first and second pluralities of pulses having a first duty cycle. The second white emitter source is driven by a third plurality of pulses at the first logic level and a fourth plurality of pulses at the second logic level, the third and fourth pluralities of pulses having a second duty cycle.

Additional objects, advantages, and novel features of the invention will be set forth in part in the description which follows, and in part will become apparent to those skilled in the art upon examination of the following or may be leaned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a schematic diagram of a lamp in accordance with one embodiment of the present invention.

FIG. 2 is a graphical representation of exemplary spectra distributions for LEDs comprising the lamp of FIG. 1.

FIG. 3 is a diagrammatic view of the LEDs comprising the lamp of FIG. 1.

FIG. 4 is a diagrammatic view of a control logic for the lamp of FIG. 1 and in accordance with one embodiment of the present invention.

FIG. 5 is a flowchart illustrating a method of using a computer method for determining a dimming solution for use with the control logic of FIG. 4.

FIG. 6 is a diagrammatic view of a computer suitable for implementing the computer method of FIG. 5 in accordance with one embodiment of the present invention.

FIGS. 7A-7C are graphical representations of pulse width modulated signals for dimming solutions for the lamp of FIG. 1 and according to three embodiments of the present invention.

FIG. 8 is a graphic representation of pulse width modulated signals for dimming solutions for a lamp in accordance with another embodiment of the present invention.

FIG. 9 is a schematic diagram of a lamp in accordance with another embodiment of the present invention.

FIG. 10 is a flowchart illustrating a method of using a computer method for determining a dimming solution for use with the lamp of FIG. 9.

FIGS. 11A and 11B are graphical representations of predicted combined spectra as determined by the computer model and a reference standard daylight spectrum at a matched correlated color temperature.

FIGS. 12-14 are graphical representations of light blending of the white emitter sources of a first exemplary lamp.

FIGS. 15 and 16 are graphical representations of light blending of the white emitter sources of a second exemplary lamp.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

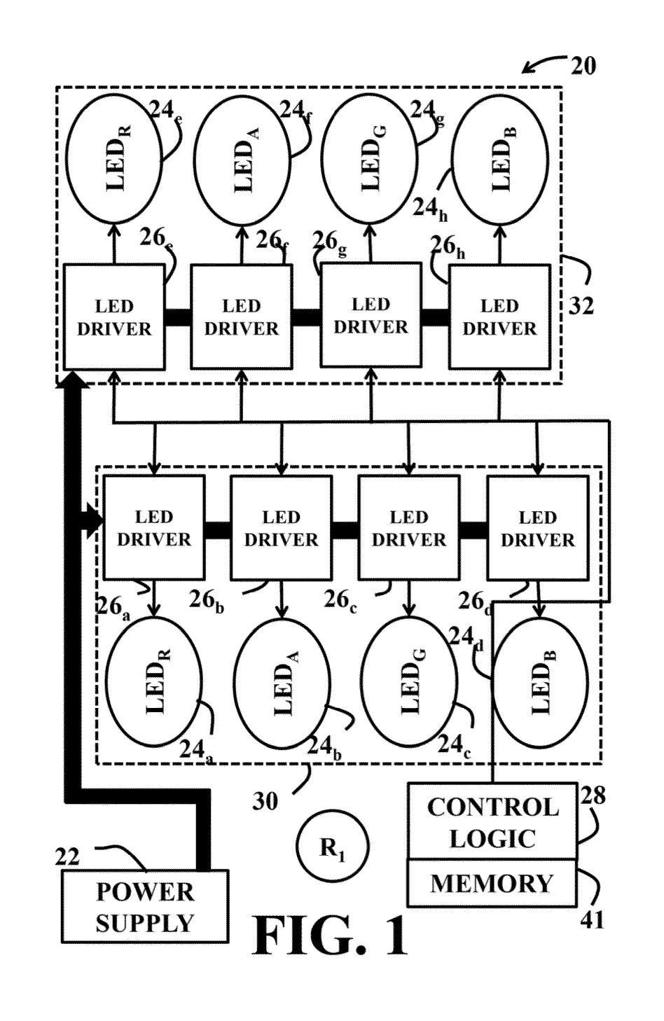

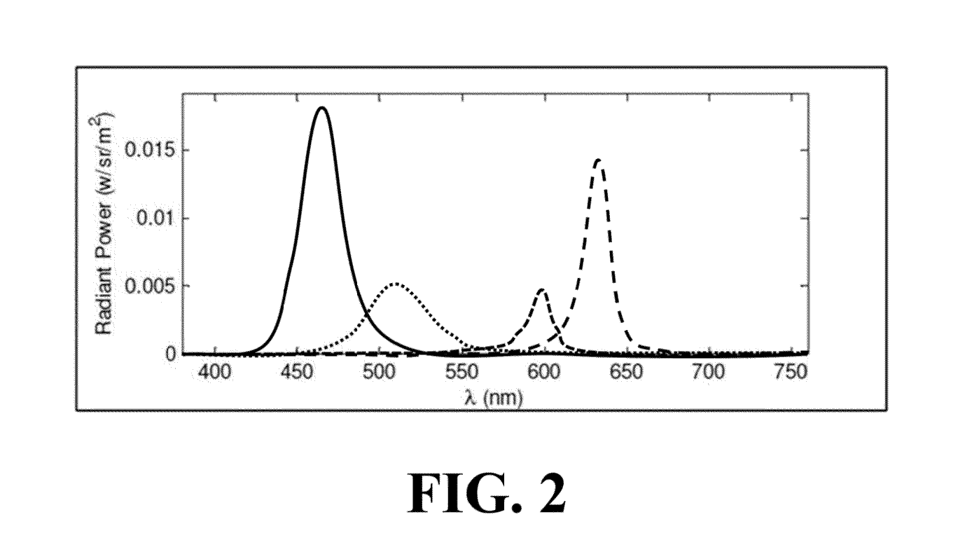

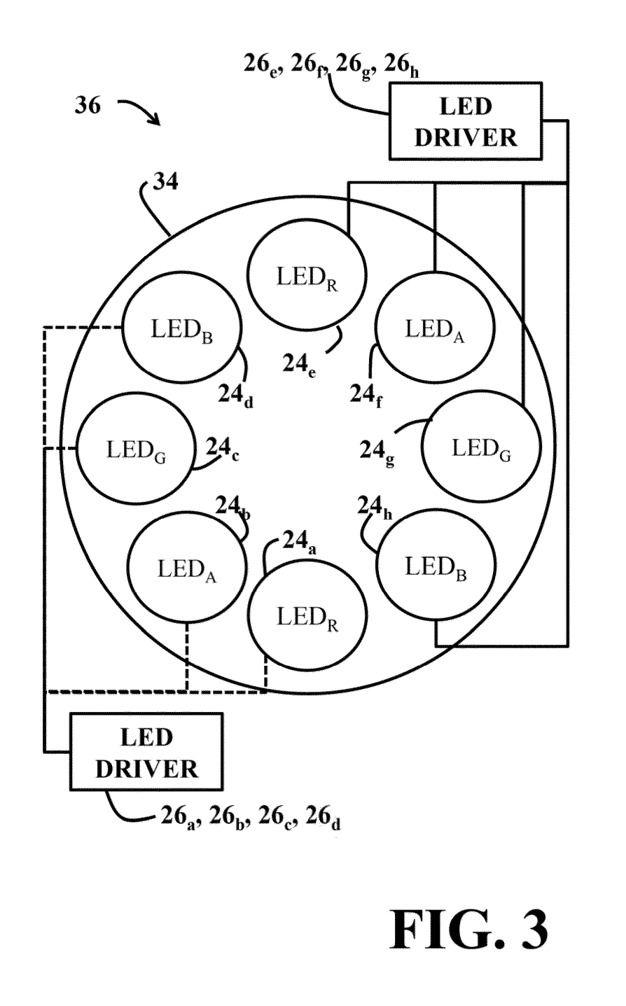

Turning now to the figures, and in particular to FIG. 1, a lamp 20 according to one embodiment of the present invention is schematically shown (FIG. 1) and includes a power supply 22, a plurality of light emitting diodes 24ₐ, 24_{b}, 24_{c}, 24_{d}, 24ₑ, 24_{f}, 24_{g}, 24ₕ, (hereafter, “LEDs,” and collectively LEDS 24ₙ), a corresponding plurality of LED drivers 26ₐ, 26_{b}, 26_{c}, 26_{d}, 26ₑ, 26_{f}, 26_{g}, 26ₕ (collectively LED drivers 26ₙ), and a control logic 28, with an associated memory 41. The LEDs 24ₙ may be organic or inorganic and may be arranged into first and second white emitter sources 30, 32 (FIG. 3) such that each white emitter source 30, 32 includes a red LED 24, 24, an amber LED 24ₐ, 24ₑ, a green LED 24ₕ, 24ᵢ, a green LED 24c, 24_{g}, and a blue LED 24_{d}, 24ₕ. For example, the LEDs 24n may produce light with spectral distributions with center wavelengths at 464 nm (blue LED 24_{d}, 24ₕ, solid line), 512 nm (green LED 24_{c}, 24_{g}, dotted line), 598 nm (amber LED 24_{b}, 24_{f}, short dashed line), and 634 nm (red LED 24ₐ, 24ₑ, long dashed line) as shown in FIG. 2. The relative amplitudes of the LEDs 24ₙ may vary, for example, with the green LEDs 24_{c}, 24g and the amber LEDs 24_{b}, 24f outputting only a fraction of the radiant power of the blue LEDs 24_{d}, 24ₕ and the red LEDs 24ₐ, 24ₑ at peak intensities.

Although not necessary. the illustrative LED drivers 26ₙ and LEDs 24ₙ of FIG. 3 are mounted (shown in a circular pattern) onto a heat sink 34 to form a lamp head 36. The LEDs 24ₙ may be configured in any number of ways, for example, so as to minimize the spatial variation in luminance as the relative luminance level of the first and second white emitter sources 30, 32 are varied, for example, by placing LEDs 24ₙ having the same center wavelengths adjacent to one another.

The LEDs 24ₙ may be operably coupled to the power supply 22, which according to some embodiments may be configured to supply a regulated DC power of about 5 volts (V) and 24 V to the control logic 28 and the LED drivers 26ₙ, respectively.

Using a precision potentiometer (illustrated as “R₁”), PWM of the LEDs 24ₙ may be configured such that light from the first and second white emitters 30, 32 is blended and unitarily controlled so as to provide a plurality of relative luminance levels wherein changing the relative luminance between the first and second white emitter sources 30, 32 result in a change in the correlated color temperature (hereafter, “CCT”) level of the light that is produced by the lamp. Accordingly, operation of the LEDs 24ₙ may be modulated, such as by pulse width modulation (“PWM”), amplitude modulation (“AM”), complex hybrid modulation, multiphase modulation, and multilevel modulation. For the sake of efficiency, embodiments implementing PWM are described herein as PWM minimizes color shifts when LEDs 24ₙ are dimmed. For example, an R₁ value of [000], corresponding to a resistance value, which may be variable, for example, between 0 and 9999 Ohms, and may be configured such that the first white emitter source 30 contributes nearly 100% (or a maximum luminance) of an output luminance of the lamp 20 while the second white emitter source 32 make negligible contribution (or a minimum illuminance) of the output luminance level of the lamp 20. As another example, an R₁ value of |300| may be configured such that the first white emitter source 30 contributes 70% to the output luminance of the lamp 20 while the second white emitter source 32 contributes 30% to the output luminance of the lamp 20.

Although not specifically shown, it would be readily appreciated by those having ordinary skill in the art having the benefit of this disclosure, R₁ may be manually adjusted, such as by a knob or switch; passively controlled by one or more photocells configured to measure an output of one white emitter source 30, 32 and provide feedback to the other white emitter source 32, 30; passively controlled by a plurality of phototransistors, each having a filter (for example, a red filter, a blue filter, a transparent filter) to measure an output of one white emitter source 30, 32 and provide feedback to the other white emitter source 32, 30.

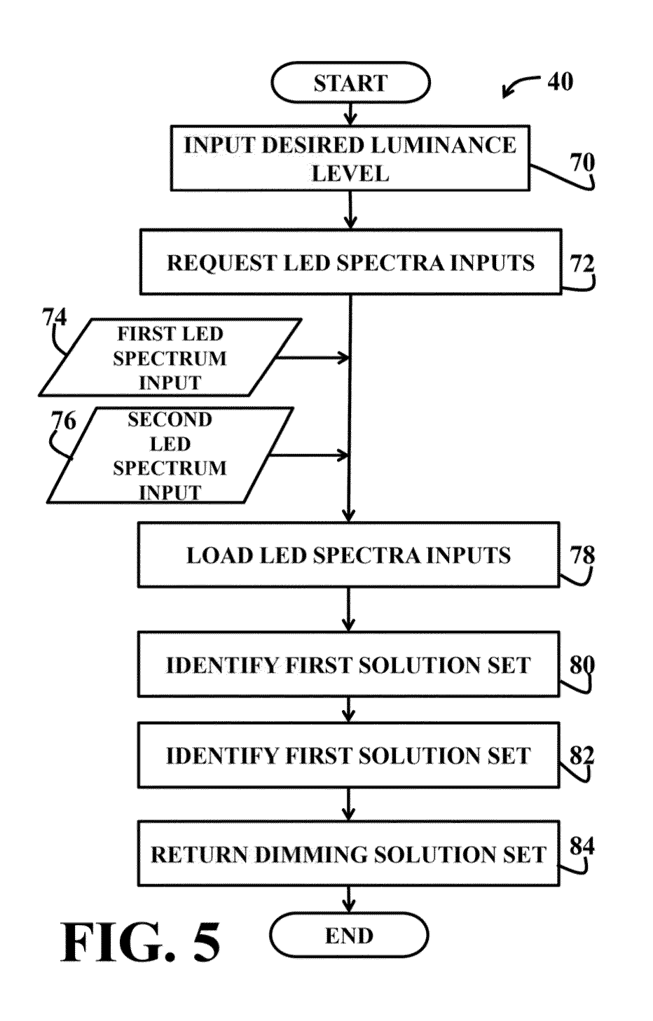

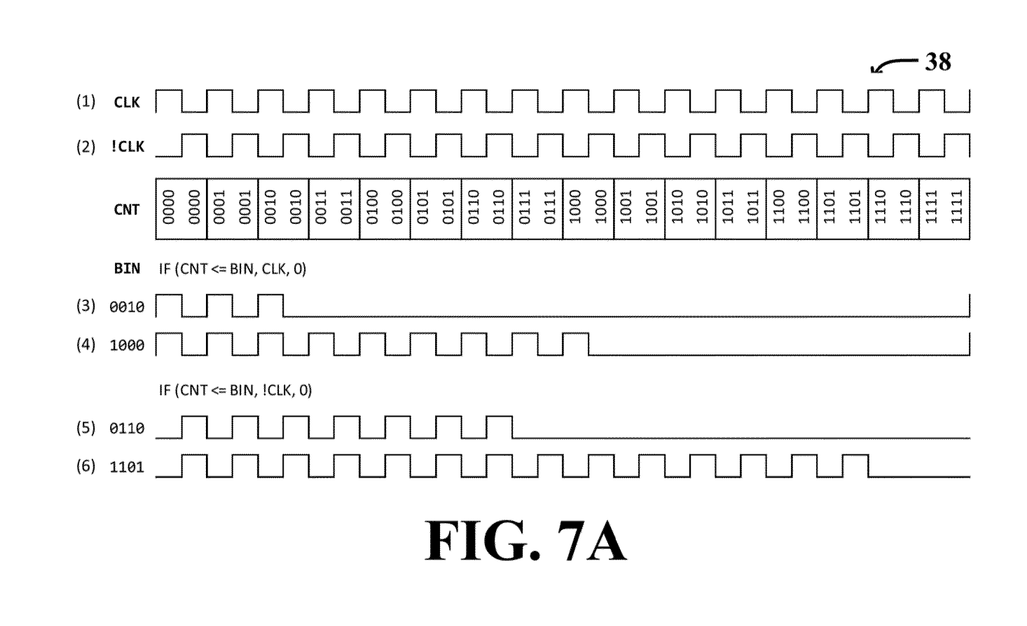

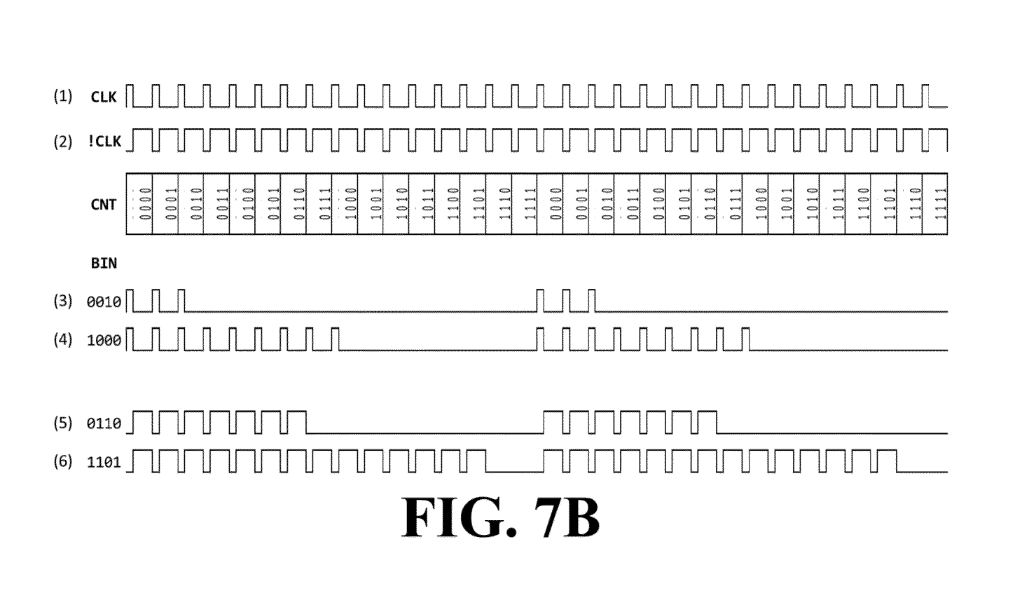

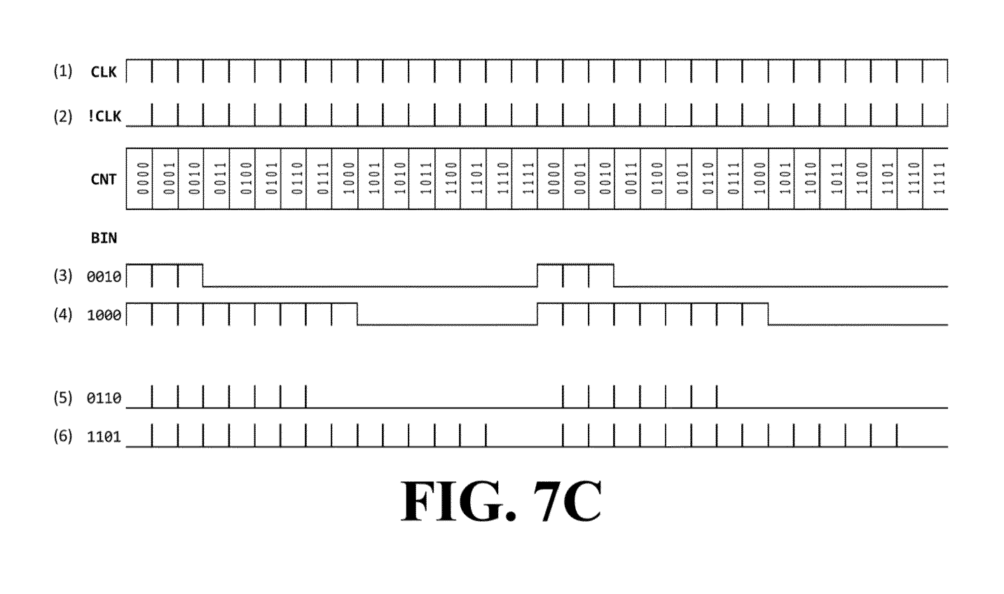

Therefore, the lamp 20 of FIG. 1 may be configured to provide a desired relative luminance level between the first and second white emitter sources 30, 32, which may be defined by one or more of a CCT level, a color quality scale (hereafter, “CQS”) level, a color rendering index (hereafter, “CRI”) value, and a color fidelity scale (hereafter, “CFS”) level, each being described previously and readily understood by those of ordinary skill in the art. In that regard, operation of the lamp 20 by way of the control logic 28 includes a PWM drive scheme 38 (FIG. 7A) representative of the dimming solution set comprising a sequential plurality of pulses (hereafter, “pulse sequence”) configured to control the first and second white emitter sources 30, 32 and achieve the desired relative luminance level for each LED 24ₙ comprising the first and second white emitter sources 30, 32, resulting in a desired relative luminance level that achieves the desired CCT. Each pulse sequence may, in turn, include a PWM signal for each LED 24ₙ comprising the respective white emitter source 30, 32. The control logic 28, described in greater detail below, is configured to accept, store, and utilize the dimming solution set, which is determined by a computer method 40 (FIG. 5). The dimming solution set, and its associated PWM drive scheme 38, may be stored in a memory 41 and to adjust the relative luminance of each LED 24ₙ of the first and second white emitter sources 30, 32, which is more efficient than the convention method of calculating adjustments.

The memory 41 of the control logic 28 be used to store the dimming solution sets for each LED 24ₙ so that the dimming solution sets may be recalled, as necessary or as desired, when the lamp 20 is activated.

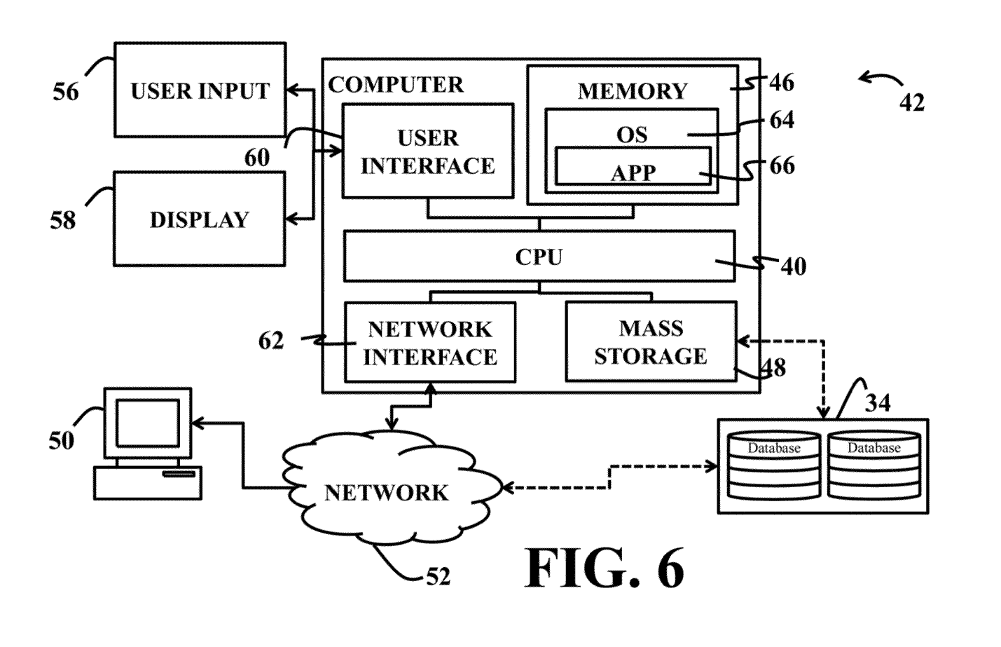

FIG. 5 is a flowchart illustrating the method of using a computer 42 (shown in FIG. 6 and described in detail below) to generate the dimming solution set for a desired relative luminance level according to one embodiment of the present invention. The model 40 may be programmed using any computer programming language, for example, MATLAB® (The Math Works, Inc., Natick, Mass.) and may accept user inputs representative of LED spectra.

The computer 42, which is shown in FIG. 6, may include at least one processor 40 (illustrated as “CPU”) coupled to a memory 46. The processor 40 may represent one or more processors (e.g., microprocessors), and the memory 46 may represent the random access memory (RAM) devices comprising the main storage of the computer 42, as well as any supplemental levels of memory, e.g., cache memories, non-volatile or backup memories (e.g., programmable or flash memories), read-only memories, etc. In addition, the memory 46 may be considered to include memory storage physically located elsewhere in the computer 42, e.g., any cache memory in the processor 40, as well as any storage capacity used as a virtual memory, e.g., as stored on a mass storage device or another computer 50 coupled to the computer 42 via a network 52. The associated mass storage device 48 may contain a cache or other dataspace, which may include one or more databases 54.

The computer 42 receives a number of inputs and outputs for communicating information externally. For interfacing with a user or operator illustrated as “USER INTERFACE” 60), the computer 42 may include includes one or more user input devices 56 (e.g., a keyboard, a mouse, a trackball, a joystick, a touchpad, a keypad, a stylus, and/or a microphone, among others). The computer 42 may also include a display 58 (e.g., a CRT monitor, an LCD display panel, and/or a speaker, among others). The interface 60 to the computer 42 may also be through an external terminal connected directly or remotely to the computer, or through another computer 50 that communicates with the computer 42 via a network interface 62 and associated network 52, modem, or other type of communications device.

The computer 42 operates under the control of an operating system (illustrated as “OS” 64), and executes or otherwise relies upon various computer software applications (illustrated as “APP” 66), components, programs, objects, modules, data structures, etc. (e.g., query optimizer and query engine).

In general, the routines executed to implement the embodiments of the present invention, whether implemented as part of the operating system 64 or a specific application 66, component, program, object, module, or sequence of instructions will be referred to herein as “computer program code,” or simply “program code.” The computer program code typically comprises one or more instructions that are resident at various times in various memory 46 and storage devices 48 in the computer 42, and that, when read and executed by one or more processors 40 in the computer 42, causes that computer 42 to perform the steps necessary to execute steps or elements embodying the various aspects of the present invention. Moreover, while the present invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to physical, recordable type media such as volatile and non-volatile memory devices, floppy and other removable disks, hard disk drives, optical disks (e.g., CD-ROM's, DVD's, etc), among others, and transmission type media such as digital and analog communication links.

In addition, various program code described hereinafter may be identified based upon the application or software component within which it is implemented in specific embodiments of the invention. However, it should be appreciated that any particular program nomenclature that follows is merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

Those skilled in the art will recognize that the exemplary environment illustrated in FIG. 6 is not intended to limit the present invention. Indeed, those skilled in the art will recognize that other alternative hardware and/or software environments may be used without departing from the scope of the invention.

Turning now again to FIG. 5, and in block 70, the desired luminance level is input into the model 40 and associated boundaries for CCT, CQS, and CRI are determined. Because the spectrum of each LED may be bounded at low and high CCT targets and include minimally acceptable CQS and CRI scores, and according to one embodiment of the present invention, the associated CCT, CQS, and CRI may be determined from a look-up table or other similarly associated database.

In block 72, LED spectrum inputs are requested. A first LED spectrum input 74 may include a number of spectra (for example, four spectra) given as a maximum measured spectral intensity for each LED 24ₐ, 24_{b}, 24_{c}, 24_{d} (FIG. 1) comprising the first white emitter source 30 (FIG. 1), which may be linearly scaled to yield 17 dimming levels for processing. A second LED spectrum input 76 may include a number of spectra (for example, 128 spectra) given as a measured spectral intensity for each LED 24ₑ, 24_{f}, 24g, 24ₕ (FIG. 1) comprising the second white emitter sources 32 over an available number of dimming levels as driven by the control logic 28. By way of example, the available number of dimming levels may be 16 (4 bits for each of 4 LEDs) plus one disabled state, or a total of 17 levels.

After loading the LED spectra inputs (Block 78), all dimming levels may be iteratively searched (Block 80) so as to identify a first solution set comprising those dimming levels having a low CCT value that is within the CCT boundary for the desired luminance level as well as one or more of a CQS score and a CRI score above the specified minimum thresholds. Optionally, the dimming level within the first solution set having the greatest CRI score may be designated as optimal.

In block 82, the method may iteratively search the dimming levels of the first solution set so as to identify a second solution set comprising those dimming levels having a high CCT value that is within value that is within the CCT boundary for the desired luminance level.

In block 84, the method may return the dimming solution set, which may include a target dimming level for each LED 24ₙ, a CRI score for the high and low CCT values and a predicted CQS score.

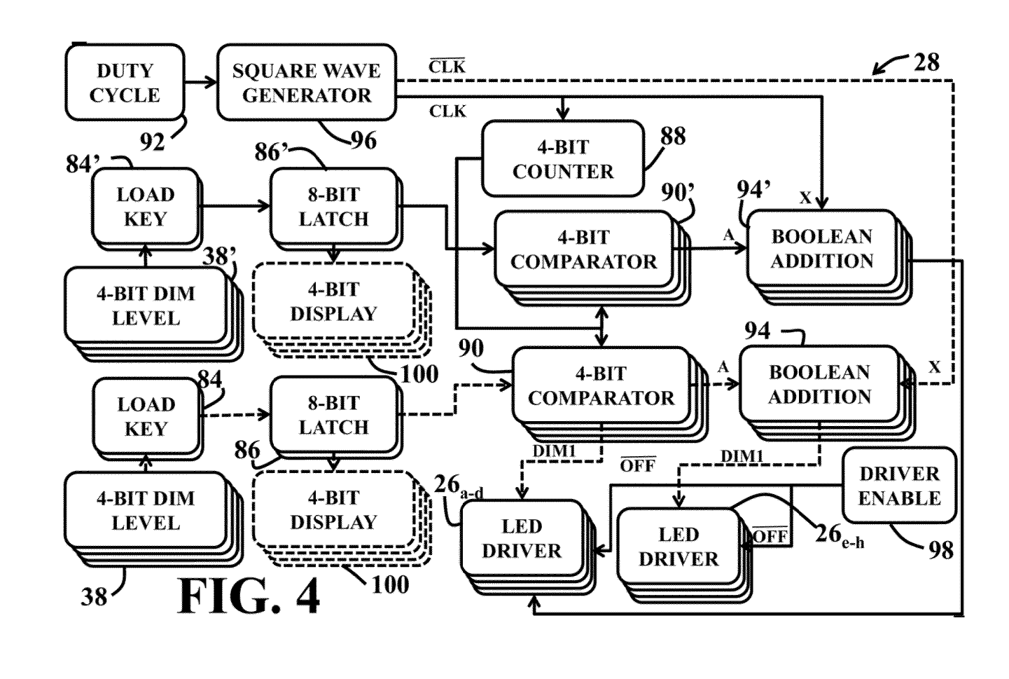

With the PWM drive scheme 38 (FIG. 7A) representing the dimming solution set for the desired level of luminance determined and stored within the control logic 28, operation of the control logic 28 and the lamp 20 are described with reference to FIGS. 1 and 4. The illustrative control logic 28 of FIG. 4 may comprise a conventional TTL and CMOS integrated circuits on an electronics breadboard. Each LED 24ₙ of the first and second white emitter sources 30, 32 is powered by a separate constant current back regulator, for example, the commercially-available National Semiconductor LM3404 evaluation board (Texas Instruments, Dallas, Tex.).

The PWM drive scheme 38 (illustrated in FIG. 4 as “4-BIT DIM LEVEL” 38, 38′), as resulting from the computer method 40, may be loaded (illustrated as “LOAD KEY” 84, 84′) and latched (illustrated as “8-BIT LATCH” 86, 86′) for comparison to a running counter (illustrated as “4-BIT COUNTER” 88) at comparators (illustrated as “4-BIT COMPARATOR” 90, 90′). A result of the comparison may be added to a duty cycle 92 adjusted clock signal (illustrated as “CLK”) or added to a duty cycle 92 adjusted inverted clock signal (illustrated as “ C̅L̅K̅”) to produce a dual PWM drive signal for controlling the respective LED drivers 26ₙ (FIG. 1).

A PWM drive scheme 38 of exemplary dimming solution set, shown in FIG. 7A, includes two dual pulse width modulation signals sent to LEDs 24ₙ of the same color in both the first and second white emitter sources 30, 32. The first white emitter source 30 may be configured to operate from a standard clock signal (illustrated as “CLK” in FIGS. 4 and 7A) while the second white emitter source 32 may be configured to operate from an inverted clock signal (illustrated “!CLK” in FIG. 7A and C̅L̅K̅ FIG. 4) such that the duty cycle 92 of each clock signal proportionally dims the respective white emitter source's constructed spectrum. Accordingly, the PWM signal received by each LED driver 26ₙ includes a series of clock pulses so long as a running count is less than or equal to the corresponding LED's desired dimming level (illustrated command, “IF(CNT<=BIN, CLK,0”). In other words, the two signals may be combined, for example, through a simple additive Boolean operation (illustrated as “BOOLEAN ADDITION” 94 in FIG. 4), such as, “If A=TRUE, then X; else FALSE,” to produce a single signal which incorporates the dimming level information for both source solutions as well as blending information provided by adjustment of the duty cycle 92. The Boolean addition 94, 94′ is readily applicable to the illustrative embodiment as die signals are a half cycle out of phase (via the SQUARE WAVE GENERATOR 96, which is configured to produce a square wave having the duty cycle determined by DUTY CYCLE 92), which effectively allows four LEDs 24_{a-d}, 24ₑ₋ₕ to emit light at a level and a proportion necessary to produce light at the desired CCT value. The SQUARE WAVE GENERATOR 96 may also provide the standard and inverted clock signals.

DRIVER ENABLE 98, 98′ functions enable each LED DRIVER 26ₙ to be separately and individually disabled, e.g., effectively turning off or enabling the respective LED 24ₙ. The PWM signal may be processed by the LED DRIVER 26ₙ and drives the respective LED 24n so as to produce light at the desired dimming level. Since all practical emitter sources are constructed from some combination of spectra, the LED DRIVER 26n would be constantly enabled. But for testing and evaluation, for normal operation of the lamp 20, the DRIVER ENABLE 98, 98′ would remain at an enabled level.

Optionally, and as shown in FIG. 4, a 4-BIT DISPLAY 100, 100′, may display a loaded dimming solution bit pattern, such as by an LED indicator array.

According to the embodiment illustrated in FIG. 7A, the standard clock signal, at an exemplary 50% duty cycle (i.e., a 50% blend of first and second white emitter sources 30, 32), is shown at Line (1) while the inverted clock signal is shown at Line (2). A recycling, counter signal, shown between Line (2) and Line (3), counts each rising edge of the standard clock signal. Lines (3) and (4) in FIG. 7A are representative of dual PWM signals sent to two LEDs, for example, the blue and green LEDs (LED_{G}, LEDₙ) of first white emitter source 30, which are driven at dimming levels [0010] and [1000], respectively, which arc the dimming levels returned (LOAD KEY 84, 84′) from the dimming solution set, stored. and recalled from the memory 41. Similarly, Lines (5) and (6) in FIG. 7A are representative of dual PWM signals generated from a dimming solution recalled from the memory 41 and provided in the same two color LEDs of second white emitter source 32, which are driven at dimming levels [0110] and [1101], respectively.

FIGS. 7B and 7C are similarly arranged with the exemplary duty cycle being 20% duty cycle (20% blend of the low CCT source with 80% of the high CCT source) over two full counter cycles and a 99% duty cycle (99% of the low CCT source with 1% of the high CCT source) over two cycles of the counter, respectively. Effectively, in FIG. 7C, the power is being directed to the low CCT source LEDs with signals shown in Lines (3) and (4) and while power is simultaneously directed away from the high CCT source LEDs (e.g., LEDs 24_{e-f} of the second white emitter source 32). This is supported by the fact that during an initial portion of the pulse sequence, the signal level for Lines (3) and (4) is 1 for approximately the entire time while the signal level for Lines (5) and (6) is 0, which results from driving the high CCT source (second white emitter source 32) with the inverted clock signal while driving the low CCT source (first white emitter source 30) with the standard clock signal. As such, these changes illustrate that the control logic 28 (FIG. 1) provides a pulse width modulated drive signal comprising a first plurality of pulses at a first logic level (for example, 0) and a second plurality of pulses at a second logic level (for example, 1), as is illustrated by Line (3) of FIGS. 7A-7C. Thus, a ratio of the number of pulses in the first and second pluralities may be controlled. Additionally, the pulse width modulated drive signal includes a mechanism (for example, the standard clock signal) by which a duty cycle of each pulse of the first and second pluralities, as indicated by Line (5) of FIGS. 7A-7C, may be controlled.

If desired, and to reduce flicker when at least one of the white emitter sources 30, 32 is operated at minimum levels, the PWM signals may be sent to the respective LED driver 26ₙ at a nominal clock frequency, for example, a clock frequency of 9.6 kHz. In those embodiments using a 4-bit binary counter, an effective dimming cycle frequency may be 600 Hz, which is well above the human critical flicker frequency.

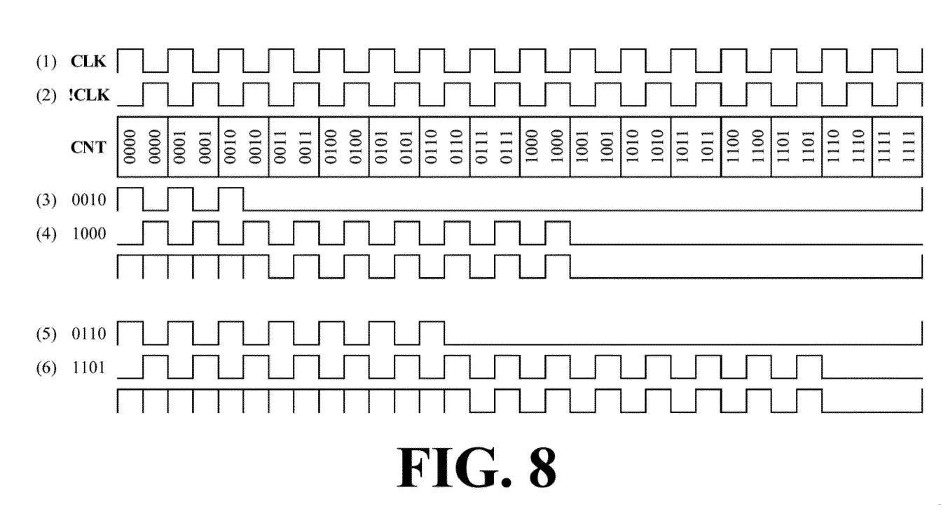

If desired, and in accordance with an alternate embodiment of the present invention, the number of LEDs may be reduced by implementing a time-shared dual-PWM scheme, one example of which is shown in FIG. 8. In the illustrative example, dual PWM drive signals (Lines (3) and (4)) for LEDs of the first and second white emitter source, [0010] and [1000], which arc assumed to be the same color, are logically combined to produce a single time-shared dual-PWM signal (shown between Lines (4) and (5)) for that particular color LED and transmitted to the respective LED drivers. Similarly, the second signals, [0110] and [1101], may also he combined (shown after Line (6)) and transmitted to the respective LED drivers. According to this embodiment of the present invention. LEDs 24ₙ having the same color (e.g., amber LEDs 24_{b}, 24_{f}) may be simultaneously driven with the combined signal or, alternatively, the lamp may be simplified to include on a single LED of that color. Resultantly, light from the white emitter sources 30, 32 may be temporally integrated and not spatially integrated while still providing two effective white emitter sources that variably control the produced color temperature.

According to an yet another embodiment, the number of LEDs may be increased by any multiple of the number of differently colored LEDs (such as 4 LEDs as described herein), thereby increasing the luminance of the lamp and minimizing the effects of center wavelength and spectral, distribution variations within any particular color of LED. This method can also he expanded to include additional LEDs of different colors to increase the lamps rendering quality.

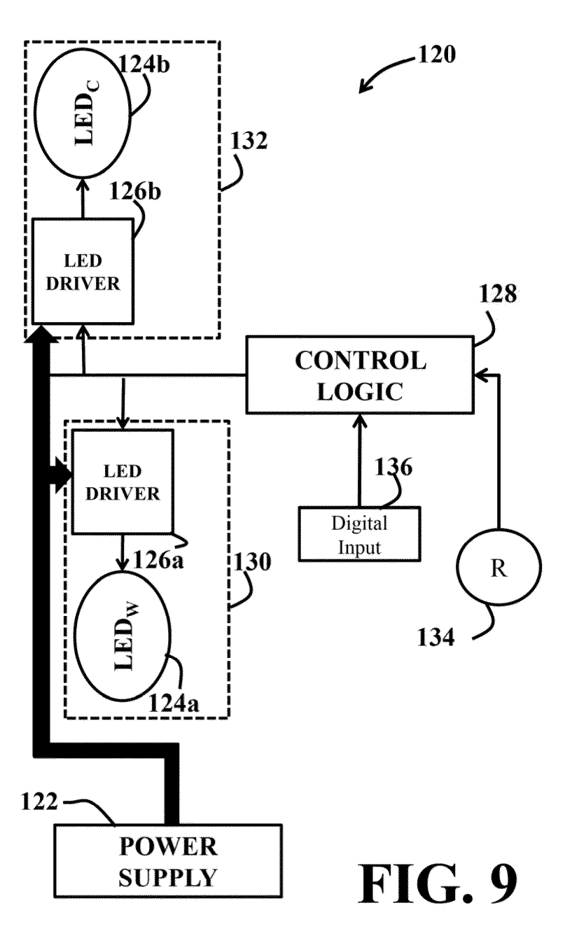

Turning now to FIG. 9, a lamp 120 according to another embodiment of the present invention is shown and includes a power supply 122, a plurality of LEDs 124ₐ, 124_{b} (collectively LEDs 124ₙ), a corresponding plurality of LED drivers 126ₐ, 126_{b} (collectively LED drivers 126ₙ), and a control logic 128. The LEDs 24ₙ may be organic or inorganic and comprise first and second white emitter sources 130, 132. For example, a first LED 124a may be a warm white LED, such as the commercially-available XLAMP XB-D (CREE, Inc., Durham, N.C.), which produces white light haying a CCT of 5000 K. A second LED 124b, for example, may be a cool white LED, such as the commercially-available XLamp XR-C (CREE, Inc.), which produces white light having a CCT of 8300K.

The LEDs 124ₙ may be operably coupled to the power supply 122, which according to some embodiments of the present invention, may be configured to supply a regulated DC power of about 5 V and 24 V to the control logic 128 and the LED drivers 126ₙ, respectively.

Using a precision potentiometer 134 to adjust resistance R₁, operation of the LEDs 124ₙ may be configured such that light from the first and second white emitter sources 130, 132 is blended and unitarily controlled so as to provide a plurality of relative luminance levels. That is, changing the relative luminance between the first and second white emitter sources 130, 132 changes the correlated color temperature of the light produced by the lamp 120. Accordingly, operation of the LEDs 124ₙ may be modulated as described previously and, hereafter, as PWM. For example, an R₁ value of [000], corresponding to a resistance value may be varied, from between 0 ohms and 999 ohms, such that the first white emitter source 130 contributes nearly 100% (or a maximum luminance) of an output luminance of the lamp 120 while the second white emitter source 132 make negligible contribution (or a minimum luminance) of the output luminance level of the lamp 120. The resulting illumination may have a CCT equal to the CCT of the first white emitter 130. As another example, an R₁ value of [300] may be configured such that the first white emitter source 130 contributes 70% to the output luminance of the lamp 120 while the second white emitter source 132 contributes 30% to the output luminance of the lamp 120.

The lamp 120 of FIG. 9 may be configured to provide a desired relative luminance level between the first and second white emitter sources 130, 132, which will result in a CCT level ranging between the CCT levels of the white light producing LEDs 124a, 124b. Operation of the lamp 120, by way of the control logic 128, may include a dimming value, which is controlled by digital input 136, resulting in a desired overall luminance level of the lamp 120 at the desired color temperature. Again, each pulse sequence may, in turn, include a PWM signal for each LED 124ₙ comprising the respective white emitter source 130, 132. This dimming solution set is utilized by the respective LED driver 126ₙ to adjust the total luminance of the two LEDs 124a, 24b within the first and second white emitter sources 130. For example, when the digital input is [0000], the lamp 120 will output little, if any, light. As the digital input is increased, the luminance output of the lamp 120 will increase until a maximum value [1111] is applied and the lamp will, resultantly, produce the maximum possible luminance. It would be readily appreciated by the skilled artisan having the benefit of the disclosure provided herein that the CCT level of the lamp 120 may be varied by adjusting the relative luminance between the white emitter sources 130 and 132, while the luminance is adjusted by adjusting the digital input 136.

The control logic 128 may be implemented as was shown in FIG. 4 and described previously with signals, such as the examples of FIGS. 7A-7C. The digital input 136 may control the sequential plurality of pulses while the precision potentiometer 134 may control the width of each pulse comprising the sequence. However, one skilled in the art having the benefit of this disclosure will realize that alternative approaches are also possible.

According to still another embodiment of the present invention, the control logic 128 (FIG. 9) may comprise, at least in part, a digital processor. For example, an Arduino Microprocessor (Arduino Software, Santa Fe, Argentina) may be attached to a prototyping board, such as the Arduino Uno REV 3 (Arduino Software), which permits the microprocessor to operably control the signal to the LED drivers 126ₙ (FIG. 9). The digital processor may implement the control logic to receive a color signal, for example, by a process illustrated by the flowchart 140 of FIG. 9.

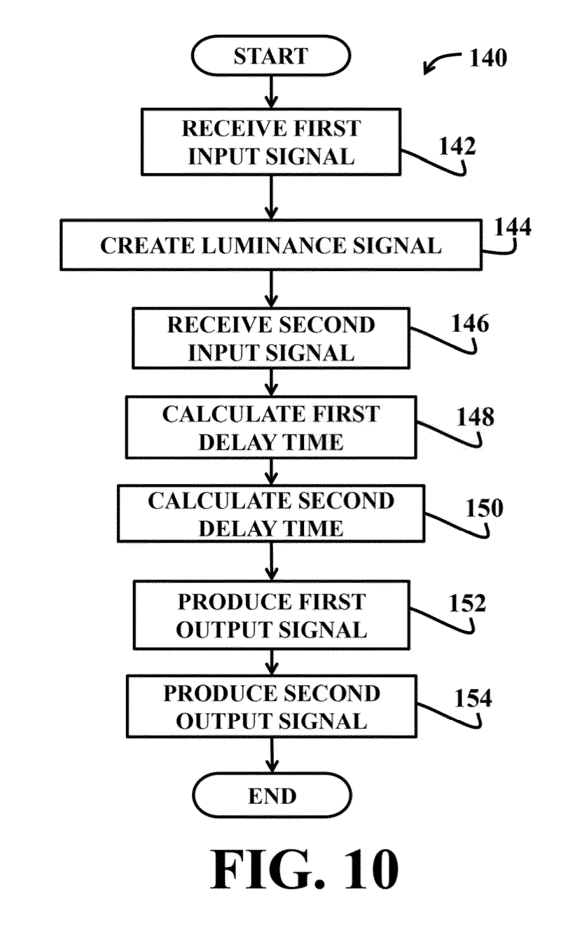

As shown in FIG. 10, and in block 142, a first input signal 142, for example an 8 bit digital signal, may be received and a luminance signal created therefrom (Block 144). The luminance signal may be, for example, a digital value used to produce an 8 bit pulse-width modulated signal through an analog output on the microprocessor (e.g., using the analog “Write” command on the Arduino Microprocessor). The pulse width modulated signal may be provided to both the first and second LED controllers for the first and second emitter sources 130, 132 (FIG. 9) and will produce the luminance of the boards, described as the first and second output signals below.

In block 146, a second input signal is received by the microprocessor and a first delay time is calculated (Block 148) therefrom. For example, and if each bit is to be output from the microprocessor for a time that is no longer than 8000 μs, the time may be divided into a predetermined number of steps, then the second input signal would have a value ranging from 0 and the number of steps. A first delay time may then be determined (Block 148) and may be proportional to the second input signal (e.g., if the second input signal is 63 within an 8 bit signal, then the delay time might be determined to be

$$\frac{64}{256} *$$

8000 μs. The second delay time may be determined in block 150 by calculating the remaining time that each bit is to be output (e.g.,

$$8000 μ s - \frac{64}{256} * 8000 μ s ) .$$

In block 152, a first output signal for driving the first white emitter source 130 (FIG. 9) may be produced by outputting the 8 bit signal with each bit being output with a delay equal to the first delay time (from Block 148). In block 154, a second output signal for driving the second white emitter source 132 (FIG. 9) may be produced by outputting the 8 bit signal with each bit being output with a delay equal to the second delay time (from Block 150). As such, pulse sequences, similar to those shown in FIGS. 7A-7C.

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

### EXAMPLE 1

Because a large portion of daylight falls within the range of 4009 K to 800(1 K, a source having a desired luminance level associated with CCT targets of 4000 K (low CCT) and 8000 K (high CCT) was selected. The selection of bounding values of 3800 K to 4300 K for the low CCT and 7800 K to 8500 K for the high CCT was made so as to reduce the number of computations performed for combined spectral data flailing outside the general range of the source location.

Because the available LEDs for a lamp constructed in a manner similar to the embodiment illustrated in FIG. 1 had less than ideal center wavelengths, minimum CQS and CRI scores were set at 55 and 40, respectively, for both sources, so as to capture enough chromaticity points for additional analysis.

Spectral data were collected from the lamp output using a SpectraDuo® PR680L spectroradiometer (Photo Research, Inc., Chatsworth, Calif.) and SRS-3 diffuse reflectance standard over eleven blending ratios by setting R₁ to [000, 100, 200, 300, 400, 500, 600, 700, 800, 900, and 999]. Measurements were taken in an improvised dark room where the dark light level was effectively 0 lux at the surface of the SRS-3, which was below the detectable threshold of the PR680L and a T-10 illuminance meter (Konica Minolta Sensing, Shanghai, China). A stationary tripod held the PR680L objective lens at a distance of 25 inches from the surface of the SRS-3, with an incline of 36°.

The SRS-3 was located 15 inches below the lamp. The PR680L in a luminance and radiance configuration and using a 2° observer, averaged five samples for each reading for all measurements.

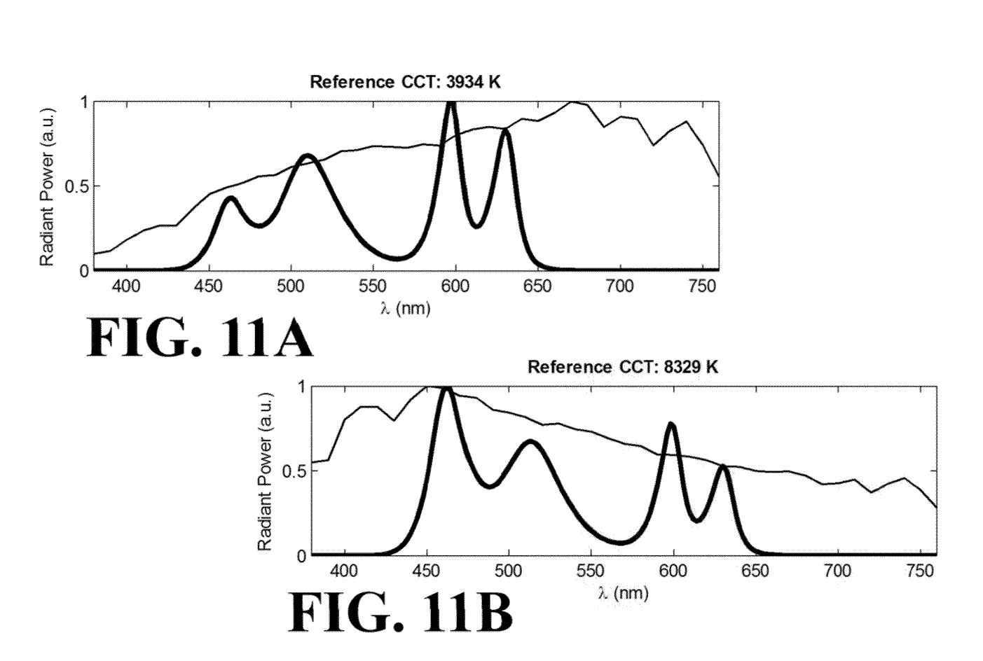

A computer model similar to the embodiment illustrated in FIG. 5 was used to determine a dimming solution set. Resultant values represent sealing factors applied relative to each LED's maximum measured power spectra, shown in the Table, below, generated a predicted combined spectra, shown in FIGS. 11A and 11B, for the first (Low) and second (High) white emitter sources, respectively.

TABLE

| Source | CCT | CRI | Red | Amber | Green | Blue |
|---|---|---|---|---|---|---|
| 1^{st} White | 3934 | 62 | 0.1875 | 0.6875 | 0.4375 | 0.0625 |
| emitter | | | [0010] | [1010] | [0110] | [0000] |
| (e.g., Low) | | | | | | |
| 2^{d} White | 8329 | 59 | 0.1875 | 1.000 | 0.9375 | 0.2500 |
| emitter | | | [0010] | [1111] | [1110] | [0011] |
| (e.g., High) | | | | | | |

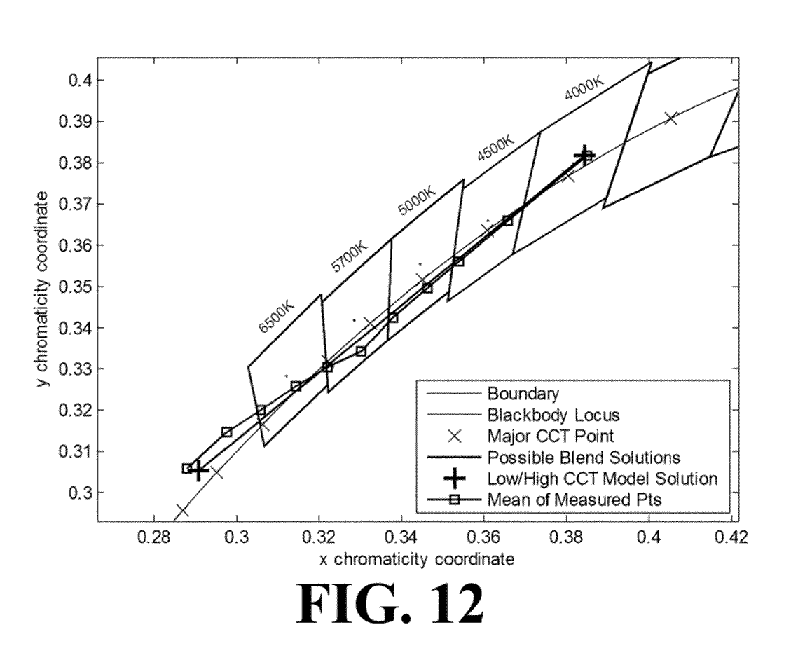

The dimming solution was loaded into the control logic for the lamp for measurement and evaluation. The lamp's response is shown in FIGS. 12-14, include the arithmetic mean values of three separate, repeated measurements of the lamp's output.

Blended points, depicted as squares (the mean of measured points) in FIG. 12, generally follow a straight-line blending trend and was predicted by the model, which is represented by a straight line connecting low and high CCT model solution endpoints. A mid-blending point, that is when the first and second white emitter source are contributing 50% of maximum output, dips below the target blending line at about a CCT of 5500 K; however chromaticity coordinates remained within the standard ANSI color temperature boxes for solid-state lighting. Points on the warm side of the midpoint fell below the target line, whereas points on the cool side fell above the target line.

The lamp's output also demonstrated unequal steps in CCT between the blended points. The inequality is most noticeable between the endpoints and an adjacent blended step. Discounting the endpoints, an overall trend revealed larger steps in CCT as blending moved toward the second white emitter source (e.g., the High CCT source). A simple regression (R²=0.997) shows that a desired CCT is obtained, over the designed minimum and maximum range, by adjusting the value of R₁:

R₁=−3×10⁻⁵CCT²+5.9×10⁻¹CCT−1.9×10³

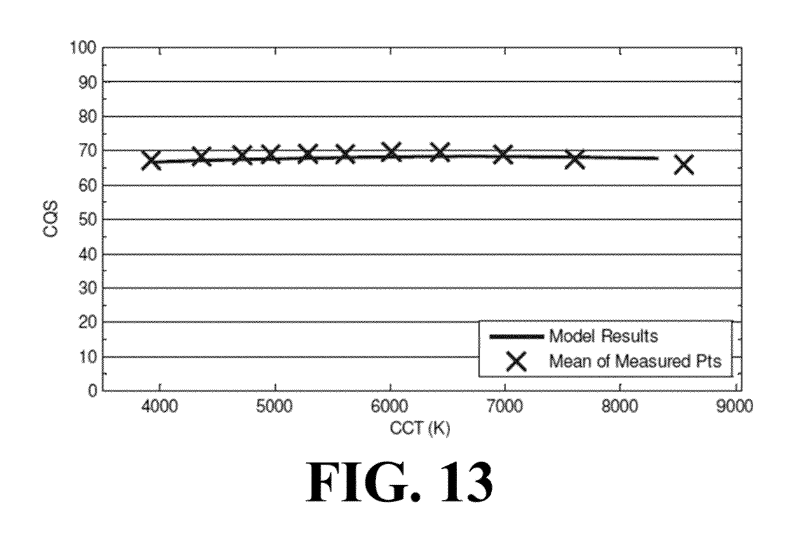

However, a CCT match alone does not adequately specify the performance of the lamp since a colorimetric match to standard daylight is desired. Thus, the lamp's ability to provide a colorimetric match to daylight was evaluated using the CQS scoring method. Average CQS scores (X) of the lamp's output is shown FIG. 13 alongside a predicted score (line) as determined by the computer model.

With the exception of the two highest measured CCT points, the lamp spectra returned a CQS score, which was relatively constant and slightly greater than the model prediction. While a CQS score in the upper 60's is not conventionally ideal nor practical for critical lighting applications, the CQS score of the lamp was found to be among the best available from blending the output of the four selected commercially-available LEDs.

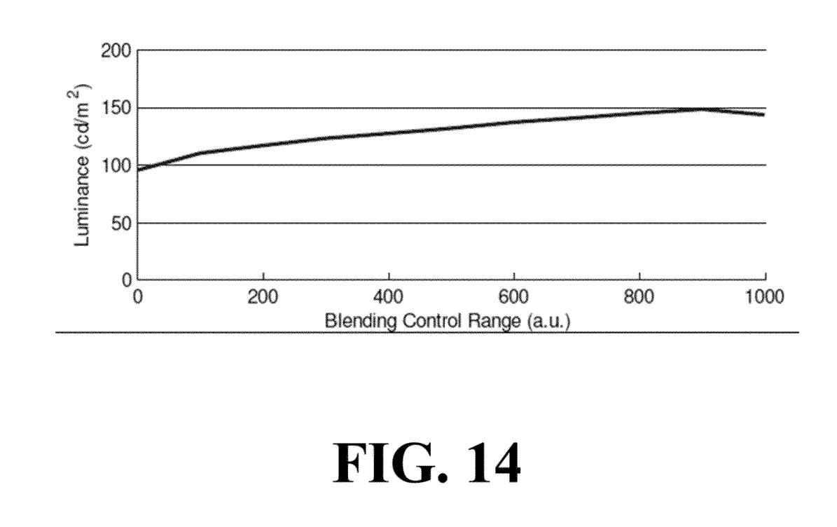

FIG. 14 graphically represents the lamp's overall luminance levels, which follows a linearly increasing trend within the 10% to 90% blending range. No effort was made to force the model toward a solution containing sources with equal individual luminance levels as well as maximized calorimetric matches, The greater luminance value of the high CCT source was to be expected since the model's solution set indicated that the amber. green, and blue LEDs must be driven at a greater power level than those of the low CCT source.

### EXAMPLE 2

A lamp, similar to the embodiment illustrated in FIG. 9, was constructed with the control logic being provided by applying an Arduino Uno REV 3 microcontroller (Arduino Software). Warm and cool, high power, white LEDs were used, with the cool white LED having a color temperature of 2800 K as measured with the SpectraDuo® PR680L spectroradiometer (Photo Research, Inc., Chatsworth, Calif.) and the warm white LED having a color temperature of 6000 K as measured with the same device. Each LED was an inorganic LEDs formed by coating a blue LED with a yellow phosphor. A separate microcontroller was used to collect two separate digital signals in response to a pair of user controls and to transmit these signals to the Arduino Uno REV 3 microcontroller, which implemented the signals in a manner similar to the process depicted in FIG. 10. The lamp, as constructed, permitted a user to adjust a color of the lamp from 0 to 100% by a first linear controller attached to the microcontroller and to adjust a luminance output of the lamp from 0 to 100% by a second linear controller attached to the microcontroller.

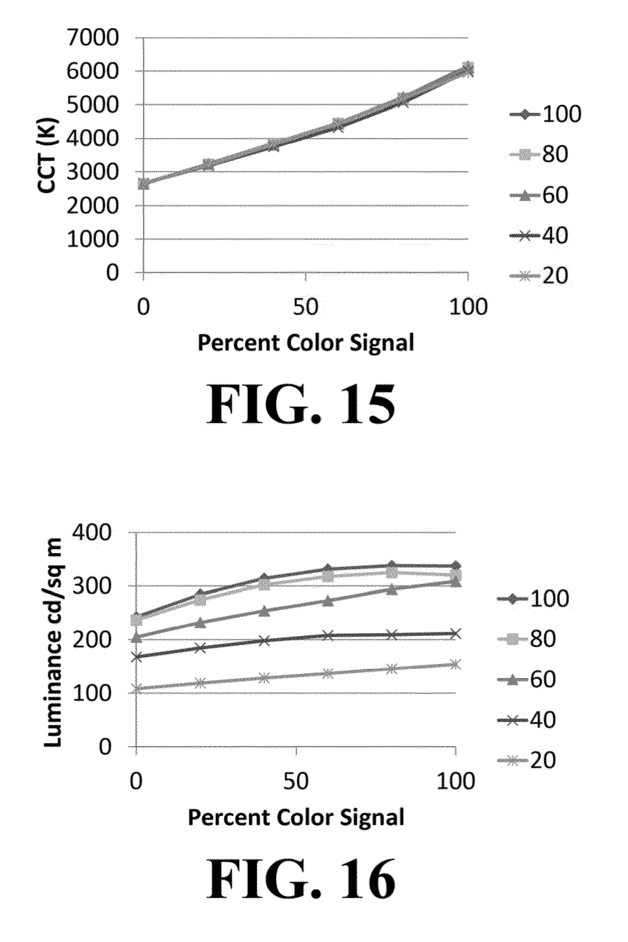

The CCT levels of the constructed lamp, measured as a function of percent color of the lamp was adjusted between 0 and 100 is shown in FIG. 15. Color measurements are also shown as luminance values were varied in 20% steps, ranging from 20% to 100%. As shown, as the color control is adjusted between 0 and 100 percent, the CCT of the lamp was adjusted between 2800 K and 6000 K. As the luminance control was adjusted, there was no effect on the CCT level of the lamp, which is shown by the five coincident lines representing five different luminance levels.

FIG. 16 graphically illustrates the luminance output of the lamp as the same color and luminance controls were produced. Unexpectantly, the LED having the higher color temperature produced a luminance greater than (not equal to) a luminance of the lower color temperature LED. While the luminance of the lamp increases slightly as the percent color is increased, the amount of increase was less than the change produced by varying the luminance control. Variation in the luminance level with color change could be controlled by adjusting the driver such that both LEDs produce the same measured luminance output. However, having the lamp dim slightly as the color temperature is reduced was considered to be visually pleasing and may be more acceptable in practice than a lamp that does not dim as the color temperature is reduced.

As provided in detail herein, a lamp, according to various embodiments of the present invention, is configured to provide a simplified approach to adjustable CCT. The lamp may produce a daylight spectra approximation by blending two fixed-CCT sources and without the need for ongoing complex calculations when the lamp is employed. LEDs comprising the lamp may be organic or inorganic and, indeed, the lamp may comprise other white emitter sources known to those of ordinary skill in the art. Dimming schemes associated with the lamp and according to various embodiments of the present invention are configured to permit blending of illumination sources to produce light at intermediate CCTs through changes to a single value with resulting blended points having color quality scores equal to or higher than the unblended high and low CCT sources. Further, some embodiments of the present invention may he configured to operably control a second value, such as luminance, independently of the color or CCT. Lamps, according to the various embodiments of the present invention, provide intuitive methods for user control while eliminating complex and costly controllers.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures ma be made from such details without departing from the scope of the general inventive concept.

1. A color adjustable lamp comprising:
a first white emitter source comprising a plurality of colors and configured to emit a first combined spectrum of light;
a first drive signal configured to operably control the first white emitter source, the first drive signal comprising a first plurality of pulses at a first logic level and a second plurality of pulses at a second logic level, the first and second pluralities of pulses having a first duty cycle; and
a first duty cycle signal configured to change the first duty cycle,
wherein a change in a ratio of pulses of the first and second pluralities, the first duty cycle by the first duty cycle signal, or both changes the first combined spectrum of light.

2. The color adjustable lamp of claim 1, further comprising:
a second white emitter source comprising the plurality of colors and configured to emit a second combined spectrum of light;
a second drive signal configured to operably control the second white emitter source, the second drive signal comprising a third plurality of pulses at the first logic level and a fourth plurality of pulses at the second logic level, the third and fourth pluralities of pulses having a second duty cycle; and
a second duty cycle signal configured to change the second duty cycle,
wherein a change in a ratio of pulses of the third and fourth pluralities, the second duty cycle by the second duty cycle signal, or both changes the second combined spectrum of light.

3. The color adjustable lamp of claim 2, further comprising:
a control logic configured to receive the first and second drive signals and to operably control the first and second white emitter sources according to the first and second drive signals, respectively, and to emit the first and second combined spectrums of light, respectively.

4. The color adjustable lamp of claim 2, wherein each of the first and second white emitter sources includes a plurality of light emitting diodes, each of the plurality of light emitting diodes corresponding to one of the plurality of colors.

5. The color adjustable lamp of claim 2, wherein each of the first and second white emitter sources includes a red light emitting diode, a blue light emitting diode, an amber light emitting diode, and a green light emitting diode.

6. The color adjustable lamp of claim 2, further comprising:
a first circuit configured to control the ratio of pulses of the first and second pluralities of the first drive signal and the ratio of pulses of the third and fourth pluralities of the second drive signal; and
a second circuit configured to control the first and second duty cycles by the first and second duty cycle signals, respectively.

7. The color adjustable lamp of claim 1, further comprising:
a control logic configured to receive the first drive signal and to operably control the first white emitter source according to the first drive signal.

8. The color adjustable lamp of claim 1, wherein the first white emitter source includes a plurality of light emitting diodes, each of the plurality of light emitting diodes corresponding to one of the plurality of colors.

9. The color adjustable lamp of claim 1, further comprising:
a first circuit configured to control the ratio of pulses of the first and second pluralities; and
a second circuit configured to control the first duty cycle.

10. A pulse width modulated drive signal comprising:
a clock signal having a variable duty cycle;
a first plurality of pulses at a first logic level; and
a second plurality of pulses at a second logic level, a number of pulses of the second plurality being variable with respect to a number of pulses of the first plurality,
wherein the variable duty cycle is configured to be independently variable from the number of pulses comprising either of the first and second pluralities.

12. A circuit configured to generate the pulse width modulated drive signal of claim 10.

13. A color adjustable lamp comprising:
a first white emitter source comprising a plurality of colors and configured to emit a first contribution to a combined spectrum of light;
a first drive signal configured to operably control the first white emitter source, the first drive signal comprising a first plurality of pulses at a first logic level and a second plurality of pulses at a second logic level, the first and second pluralities of pulses having a first duty cycle;
a second white emitter source comprising the plurality of colors and configured to emit a second contribution to the combined spectrum of light; and
a second drive signal configured to operably control the second white emitter source, the second drive signal comprising a third plurality of pulses at the first logic level and a fourth plurality of pulses at the second logic level, the third and fourth pluralities of pulses having a second duty cycle.

14. A method of adjusting the combined spectrum of light of the color adjustable lamp of claim 13, the method comprising:
adjusting the first contribution relative to the second contribution by changing a ratio of pulses of the first and second pluralities, the first duty cycle, or both.

15. A method of adjusting the combined spectrum of light of the color adjustable lamp of claim 13, the method comprising:
adjusting the second contribution relative to the first contribution by changing a ratio of pulses of the third and fourth pluralities, the second duty cycle, or both.

16. A method of generating a combined spectrum of light by a color adjustable lamp, the method comprising:
emitting a first contribution to the combined spectrum of light by driving a first white emitter source with a first plurality of pulses at a first logic level and a second plurality of pulses at a second logic level, the first and second pluralities of pulses having a first duty cycle; and
emitting a second contribution to the combined spectrum of light by driving a second white emitter source with a third plurality of pulses at the first logic level and a fourth plurality of pulses at the second logic level, the third and fourth pluralities of pulses having a second duty cycle.

17. The method of claim 16, further comprising:
adjusting the first contribution relative to the second contribution by changing a ratio of pulses of the first and second pluralities, the first duty cycle, or both.

18. The method of claim 16, further comprising:
adjusting the second contribution relative to the first contribution by changing a ratio of pulses of the third and fourth pluralities, the second duty cycle, or both.

19. The method of claim 16, wherein a digital circuit controls a ratio of pulses of the first and second pluralities of the first contribution and the ratio of pulses of the third and fourth pluralities of the second contribution and an analog circuit controls the first and second duty cycles.
